(19) United States
(12) Patent Application Publication
(10) Pub. No.: US 2026/0214023 A1
(43) Pub. Date: Jul. 23, 2026

(54) METHOD AND DEVICE FOR CONTROLLING NETWORK BASED ON O-RAN

(71) Applicant: Korea University Research and Business Foundation, Seoul (KR)

(72) Inventors: Sang Heon PACK, Seoul (KR); Dae Young JUNG, Seoul (KR)

(21) Appl. No.: 19/327,081

(22) Filed: Sep. 12, 2025

(30) Foreign Application Priority Data
Nov. 21, 2024 (KR) 10-2024-0167234

(51) Int. Cl. H04L 41/16; H04L 41/5003

(52) U.S. Cl. CPC H04L 41/16; H04L 41/5003

(57) ABSTRACT

A method of controlling a network based on an O-RAN includes requesting data collection for a distributed SON (Self-Organizing Network) from an E2 node by an SMO (Service Management and Orchestration), transmitting, by the E2 node, data in response to the request for data collection for the distributed SON to the SMO, transmitting, by the SMO, the data to a Non-RT RIC (Non-real time RAN Intelligent Controller), training, by the Non-RT RIC, an AI/ML (Artificial Intelligence/Machine Learning) model and performing inference for the distributed SON of the E2 node, and requesting, by the Non-RT RIC, reconfiguration of a central SON parameter from the SMO.

### CROSS-REFERENCE TO RELATED APPLICATION

This application claims the benefit of Korean Patent Application No. 10-2024-0167234, filed on Nov. 21, 2024, which is hereby incorporated by reference as if fully set forth herein.

### BACKGROUND

### Field

Embodiments relate to a method and device for controlling a network based on an open radio access network (O-RAN).

### Discussion of the Related Art

The importance of core networks in mobile communications has been increasing. In the field of wireless access networks, wireless access networks have the characteristics of various types of traffic, large bandwidth, and high-frequency bands, which inevitably leads to a decrease in single station coverage, an increase in device complexity, and an increase in network scale, which in turn leads to enormous network costs and increased investment return risks. Combined with these specific characteristics and requirements of wireless networks, it is necessary to introduce new development and design ideas in the field of wireless access networks.

The need for an O-RAN has been growing. The O-RAN provides openness and intelligence. This is in line with the development trend of the telecommunications industry and is another key network technology led by operators. It is expected that, by using big data, machine learning, and artificial intelligence (AI) technologies, open and intelligent radio networks may be built, and by combining open standards, white box hardware, and open source software, the cost of radio networks may be reduced.

### SUMMARY

Embodiments provide motivation, description, and requirements for an O-RAN framework to support a minimum set of Self-Organizing Network (SON) features. The embodiments seek to realize SON features in the O-RAN architectural framework, enabling operators to address challenges found in vendor-specific SON implementations in previous generation cellular networks.

However, the scope of the embodiments is not limited to the aspects described above, and the scope of the embodiments may be expanded to other aspects that may be inferred by a person skilled in the art based on the entirety of the present disclosure.

According to the present disclosure, a method of controlling a network based on an O-RAN includes requesting data collection for a distributed SON from an E2 node by an SMO (Service Management and Orchestration), transmitting, by the E2 node, data in response to the request for data collection for the distributed SON to the SMO, transmitting, by the SMO, the data to a Non-RT RIC (Non-real time RAN Intelligent Controller), training, by the Non-RT RIC, an AI/ML (Artificial Intelligence/Machine Learning) model and performing inference for the distributed SON of the E2 node, and requesting, by the Non-RT RIC, reconfiguration of a central SON parameter from the SMO.

### BRIEF DESCRIPTION OF THE DRAWINGS

The drawings are included for further understanding of the embodiments, and the drawings illustrate the embodiments together with the description related to the embodiments. For a better understanding of the various embodiments described below, reference should be made to the following description of the embodiments in conjunction with the following drawings, in which like reference numerals correspond to corresponding parts throughout the drawings. In the drawings:

FIG. 1 illustrates a structure of a Non-RT (Non-real time) RIC (RAN Intelligent Controller) according to embodiments;

FIGS. 2, 3, 4, and 5 illustrate a method of deploying a hybrid SON according to embodiments;

FIGS. 6, 7, and 8 illustrate a method of deploying the hybrid SON according to embodiments;

FIGS. 9, 10, and 11 illustrate retraining procedures according to embodiments; and

FIGS. 12 and 13 illustrate retraining procedures according to embodiments.

### DETAILED DESCRIPTION

A specific description will be given of preferred embodiments, examples of which are illustrated in the accompanying drawings. The following detailed description with reference to the accompanying drawings is intended to describe preferred embodiments rather than to illustrate only embodiments that may be implemented. The following detailed description includes details to provide a thorough understanding of the embodiments. However, it will be apparent to one skilled in the art that the embodiments may be practiced without these details.

Most of the terms used in the embodiments are selected from those commonly used in the field, but some terms are arbitrarily selected by the applicant and meanings thereof are described in detail in the following description as needed. Therefore, the embodiments should be understood based on the intended meaning of the terms and not on the simple names or meanings of the terms.

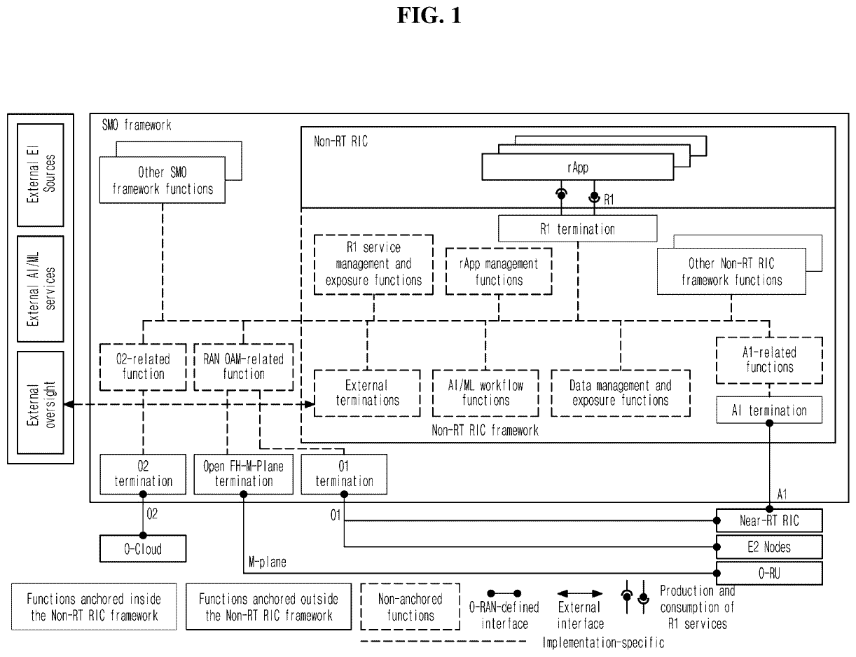

FIG. 1 illustrates a structure of a Non-RT RIC according to the embodiments.

The Non-RT RIC according to the embodiments may include a Non-RT RIC framework and a Non-RT RIC application (rApp).

Functions of the Non-RT RIC framework and an SMO framework are as follows.

The Non-RT RIC may be connected to a Near-RT RIC based on an A1 interface.

An R1 service set may be provided to the Non-RT RIC application (rApp).

The Non-RT RIC application (rApp) is an application that provides a value-added service related to RAN operation and optimization by utilizing a function available in the SMO/Non-RT RIC frameworks. rApp includes RAN configuration management, data analysis, training service creation, A1 policy creation, and reinforcement information provision.

FIG. 1 illustrates a reference architecture of the Non-RT RIC as a part of the SMO framework.

A service management and exposure function may include service registration, service search, service notification, grant of authority, authentication, communication support, optional bootstrap and heartbeat services.

An rApp management function manages rApp in the SMO/Non-RT RIC frameworks. Such a function enables (without being limited thereto) a configuration of rApp, provides access to error and performance-related information from rApp, and performs an rApp logging function. When R1 is used, the rApp management function may provide access to such a function in a consistent manner across all rApps.

A method according to the embodiments may perform an integrated SON function in the O-RAN framework.

Implementing the SON function in the O-RAN architectural framework enables an operator to address a problem found in vendor-specific SON implementation in previous generation cellular networks.

The SON function provides control over network configuration and control aspects, reducing mobile network operating costs and eliminating manual configuration of network elements from initial deployment to network operation. The SON assists in improving network performance and customer experience, and may assist in significantly improving an OPEX-to-revenue ratio and realizing avoidable CAPEX.

The SON is automation technology that allows the network to set itself up and manage resources and configurations to achieve optimal performance. The SON function is processed individually or in groups in the SON algorithm. The SON algorithm collects management data, including MDAS (Management Data Analytics Service) data, to monitor the network, and performs functions such as data analysis and resolution to identify network problems.

Self-configuration: This allows seamless integration into the network through automatic configuration of key parameters (initial PCI and ANR function).

Self-Optimization: This supports improved network performance through near real-time optimization of wireless and network configurations. It is valuable over the life of the network and includes SON functions such as Mobility Load Balancing (MLB), Mobility Robustness Optimization (MRO), and Random Access Channel (RACH) optimization.

Self-recovery: This provides resilience (reliability) even in unexpected outages by allowing neighboring cells to maintain network quality when a cell/sector fails. This is relevant for the lifetime of the network and includes SON functions such as cell outage detection, compensation, and recovery.

The SON may perform optimization based on network load (by MLB) and radio network parameters (by MLB&MRO).

The SON is associated with performance metrics such as handover and RLF, and is particularly affected by UE mobility. When a stabilized network includes UEs having abnormal mobility, the performance of the SON function may deteriorate.

Existing studies on the SON do not consider a variety of UE mobility within a wide range. That is, most scenarios are fixed to one type of mobility or are environments that mix two types of mobility.

Data required for the method according to the embodiments may be related to the mobility of the UE through GPS coordinates, and the method according to the embodiments may collect the related data.

In addition, when a UE having abnormal mobility enters a network performing the SON function, the embodiments may perform heal & scale (refer to OAM Architecture-related standard) by adjusting a life cycle of an SON application instance or adding a new AI/ML (Artificial Intelligence/Machine Learning) model.

Therefore, in order to utilize a SON function greatly affected by UE mobility in the O-RAN, 1) a UE mobility value may be added to required data of self-optimization, and 2) it is possible to add a method of adjusting an application instance lifecycle and reconstructing AI/ML models when a UE having abnormal mobility is added.

The method according to the embodiments includes a hybrid SON deployment method.

Hybrid SON function deployment requires a method to be performed between an existing central SON function and a distributed SON function. For example, relevant use cases may include resource management, load balancing, and interference control.

Assuming that the two SON functions operate based on the AI/ML models, the distributed SON function is first trained and distributed, and a central SON function may monitor data such as 1) KPIs, 2) measurements, and 3) reports of the distributed models to train and deploy the models.

Options may be included depending on whether a subject of the central SON function is the Non-RT RIC or the Near-RT RIC.

For example, for Hybrid SON Option 1, the system may be configured as follows: Central SON function: Non-RT RIC and Distributed SON function: E2 node(s), and for Hybrid SON Option 2, the system may be configured as follows: Central SON function: Near-RT RIC and Distributed SON function: E2 node(s).

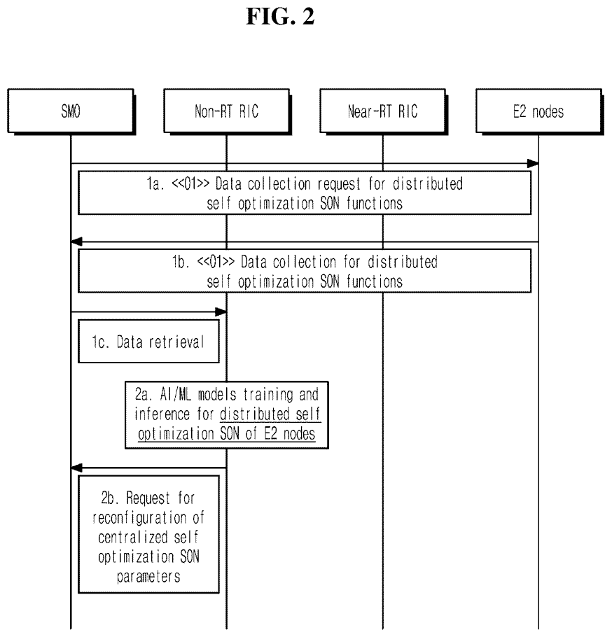

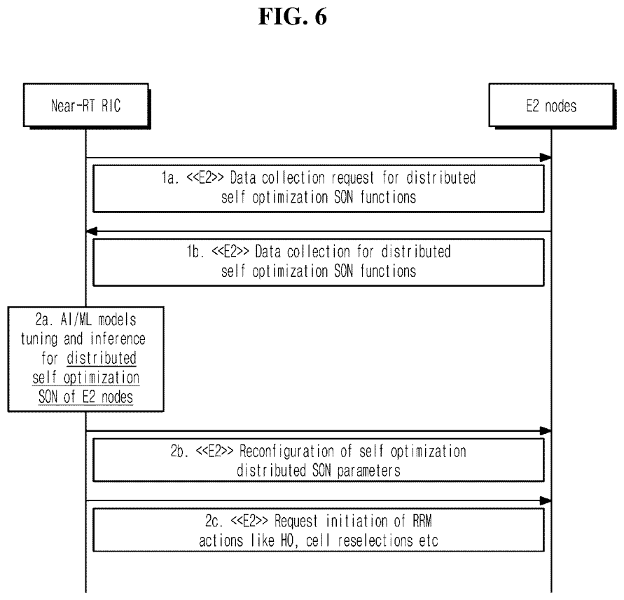

Hereinafter, hybrid SON option 1 will be described with reference to FIGS. 2 to 5, and hybrid SON option 2 will be described with reference to FIGS. 6 to 8.

FIGS. 2, 3, 4, and 5 illustrate a method of deploying a hybrid SON according to embodiments.

The method according to the embodiments may provide hybrid self-configuration SON functions such as PCI conflict detection/resolution, Automatic Neighbor Relation (ANR) and Radio Resource Management (RRM) function operation adjustment through changing configuration parameters between the Non-RT RIC and the E2 node, and allowing AI/ML-based solutions.

The SMO operates as a parameter configuration function. The Non-RT RIC performs configuration enforcement function and configuration decision-making function. The E2 node performs a configuration enforcement function and a measurement reporting function.

An O1 interface between the SMO and the E2 node is connected, and the Near-RT RIC is established. An E2 interface connection is established between the E2 node and the Near-RT RIC. The A1 interface connection is established between the Near-RT RIC and the Non-RT RIC. The network may be operated.

The SMO may configure SON functions and required initial parameters on the given O-RAN node through SON inventory and deployment management.

The operator may enable the self-configuration SON function such as PCI conflict detection/resolution, ANR, or E2 node enablement.

Detailed descriptions of steps 1 to 6 illustrated in FIGS. 2, 3, 4, and 5 are as follows.
Step 1(a-c):

The Non-RT RIC initiates specific measurement data collection requests for SMO for AI/ML model training and data analysis for distributed SON optimization, and the SMO performs initiation for the E2 node.

The E2 node sends the configured measurement data to the SMO through the O1 interface, and the Non-RT RIC collects the required data from the SMO.
Step 2(a-e):

The Non-RT RIC may train the AI/ML models for the distributed SON function with data collected from the O1 interface.

Optionally, the Non-RT RIC may create an A1 policy to initiate a handover (HO), etc., and send the A1 policy to the Near-RT RIC. The Near-RT RIC translates the A1 policy into an E2 operation and forwards the E2 operation to the E2 node.
Step 3(a-b):

The E2 node reconfigures parameters related to self-configuration.

The E2 node may initiate a specific RRM operation such as HO or cell reselection.
Step 4(a-c):

The Non-RT RIC continuously monitors the performance of E2 nodes such as measurements, reports, and KPIs to optimize the central SON function.
Step 5(a-e):

The Non-RT RIC may train the AI/ML models for a centralized SON function with data collected from the O1 interface.

The Non-RT RIC sends the output of the centralized SON function to the distributed SON function of the E2 node, and the E2 node reconfigures parameters relevant to self-optimization.
cl Step 6(a):

The Non-RT RIC continuously monitors the performance of the E2 node to optimize the centralized and distributed SON functions.

The Non-RT RIC may initiate steps 4 and 5 for parameter reconfiguration triggered by the performance of the distributed SON function.

The Non-RT RIC or the E2 node may not be operational, or the operator may disable the self-configuration SON function.

When any of the above steps fails, the SON function is not disabled.

The SMO/the Non-RT RIC, and the Near-RT RIC continue the real-time closed-loop optimization of the self-configuration SON function.

The E2 node operates using newly deployed parameters.

Referring to FIGS. 2 to 5, with respect to the hybrid SON deployment option 1 according to the embodiments, the SMO transmits a data collection request for the distributed SON to the E2 node based on the O1 interface, and the E2 node responds to the data collection request for the distributed SON. The SMO retrieves data and transmits the data to the Non-RT RIC. The Non-RT RIC may retrieve and fetch stored data or information. The Non-RT RIC trains the AI/ML model and performs inference for the distributed SON of the E2 node. The Non-RT RIC transmits a request for reconfiguration of the distributed SON parameters to the SMO.

Then, SMO transmits the reconfiguration of distributed SON parameters related to self-optimization to the E2 node based on the O1 interface. The Non-RT RIC transmits A1 policy information related to the distributed SON function related to self-optimization to the Near-RT RIC based on the A1 interface. The Near-RI RIC requests E2 service(s) corresponding to A1 policy information to the E2 node. The E2 node(s) reconfigure parameters related to the distributed SON function. An RPM operation such as HO, cell reselection, etc. is initiated.

Then, the SMO sends a monitoring data request from a distributed self-optimization SON function to the E2 nodes based on the O1 interface for central self-optimization SON functions such as measurements, reports, and KPIs. The E2 nodes respond to the monitoring data request. The SMO requests data retrieval from the Non-RT RIC. The Non-RT RIC trains the AI/ML model and performs inference for high-level network tuning. The Non-RT RIC reconfigures parameters related to the central self-optimization SON functions.

Next, the Non-RT RIC sends a request to the SMO for parameter tuning of central self-optimization SON parameters. The SMO sends a reconfiguration command to the E2 nodes based on the O1 interface with regard to parameter tuning for the distributed SON parameters related to self-optimization. The E2 nodes tune parameters related to the distributed self-optimization SON function. When parameter readjustment is required due to the KPI, the monitoring step to the parameter tuning step described above are repeated.

FIGS. 6, 7, and 8 illustrate a method of deploying the hybrid SON according to embodiments.

The embodiments enable flexible deployment of hybrid self-configuration SON functions such as PCI conflict detection/resolution, ANR through configuration parameter changes between the Non-RT RIC and the E2 node, RRM function task regulation, and allowing AI/ML-based solutions.

Near-RT RIC: This performs configuration enforcement and configuration decision-making functions. E2 node: This performs configuration enforcement and measurement reporting functions. The E2 interface connection is established between the E2 node and the Near-RT RIC. The network is working.

The Near-RT RIC configures SON functions and required initial parameters on each O-RAN node through SON inventory and deployment management.

The operator may activate self-configuration SON functions such as PCI conflict detection/resolution, ANR, etc. and the E2 node operates.

Descriptions of each step of FIGS. 6 to 8 are as follows.
Step 1(a-b):

The Near-RT RIC initiates requests to collect specific measurement data for AI/ML model training and data analysis for distributed SON optimization.

The E2 node transmits the configured measurement data to the Near-RT RIC through the E2 interface.
Step 2(a-c):

The Near-RT RIC may train the AI/ML models for distributed SON functions using data collected from the E2 interface.
Step 3(a-b):

The E2 node reconfigures parameters related to self-configuration.

The E2 node may initiate a specific RRM operation such as HO or cell reselection.
Step 4(a-b):

The Near-RT RIC continuously monitors the performance of the E2 nodes such as measurements, reporting, and KPIs to optimize the central SON function.
Step 5(a-d):

The Near-RT RIC may train the AI/ML models for the centralized SON function with data collected from the E2 interface.

The Near-RT RIC sends the output of the centralized SON function to the distributed SON function of the E2 node, and the E2 node may reconfigure the parameters relevant to self-optimization.
Step 6(a):

The Near-RT RIC continuously monitors the performance of the E2 node to optimize the centralized and distributed SON functions.

The Near-RT RIC may initiate steps 4 and 5 for parameter reconfiguration triggered by the performance of distributed SON functions.

The Near-RT RIC may initiate steps 4 and 5 for parameter reconfiguration triggered by the performance of the distributed SON function.

The above procedure terminates when the Near-RT RIC or the E2 node does not operate or the operator disables the self-configuration SON functions.

When any of the above-described steps fails, the procedure does not end.

The SMO/Non-RT RIC and the Near-RT RIC continue real-time closed-loop optimization of the self-configuration SON function. The E2 node operates using newly deployed parameters.

Referring to FIG. 6, the Near-RT RIC transmits a data collection request for the distributed self-optimization SON function to the E2 node(s) based on the E2 interface. The E2 node responds to the data collection request from the Near-RT RIC for the distributed optimization SON function based on the E2 interface. The Near-RT RIC trains the AI/ML model and performs inference for distributed self-optimization of the E2 nodes. The Near-RT RIC requests that the E2 node reconfigure self-optimization distributed SON parameters based on the E2 interface. The Near-RT RIC transmits a request for RRM operations such as HO, cell reselection, etc. to the E2 node based on the E2 interface.

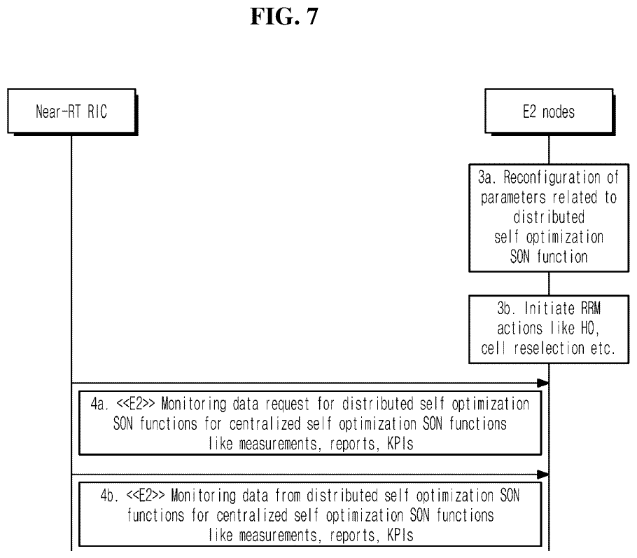

Referring to FIG. 7, the E2 node reconfigures parameters related to the distributed self-optimization SON function. The RRM operations such as HO and cell reselection are initiated. The Near-RT RIC requests monitoring data from the distributed self-optimization SON function for the central self-optimization SON function such as measurements, reports, and KPIs to the E2 nodes based on the E2 interface. The E2 nodes respond to the data monitoring request from the Near-RT RIC from the distributed self-optimization SON function for the central self-optimization SON function such as measurements, reports, and KPIs based on the E2 interface.

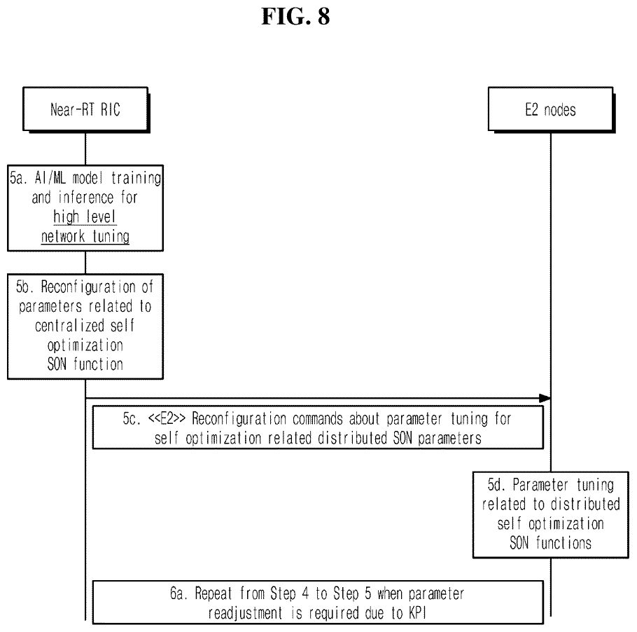

Referring to FIG. 8, the Near-RT RIC trains the AI/ML model and performs inference for high-level network tuning. The Near-RT RIC reconfigures parameters related to the central self-optimization SON function. The Near-RT RIC sends reconfiguration commands related to parameter tuning for distributed SON parameters related to self-optimization to the E2 nodes. The E2 nodes perform parameter tuning related to the distributed self-optimization SON function. When parameter re-tuning is required due to the KPIs, data monitoring or AI/ML model training/inference steps are repeated.

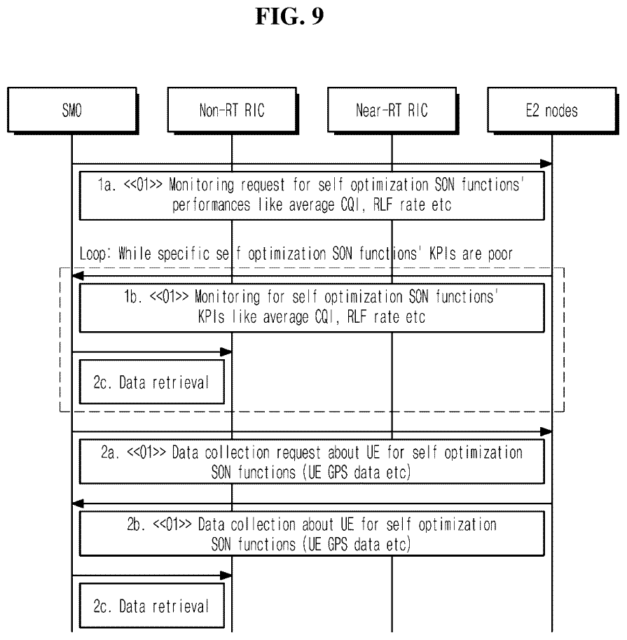

FIGS. 9, 10, and 11 illustrate retraining procedures according to embodiments.

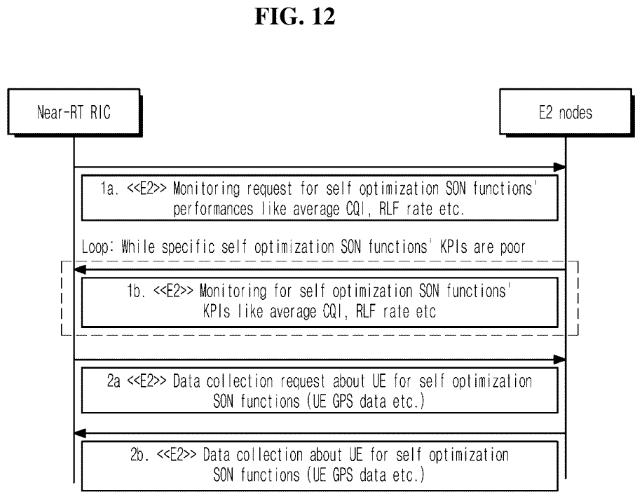

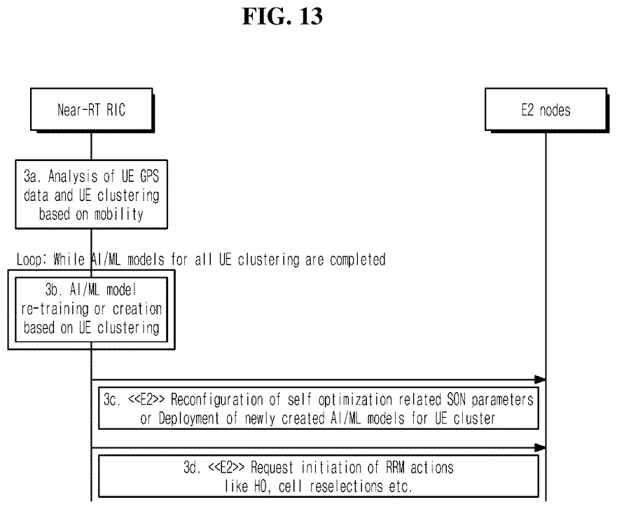

The method according to the embodiments may perform a retraining procedure considering the mobility of the UE. FIGS. 9 to 11 illustrate option 1 of the retraining procedure considering UE mobility, and FIGS. 12 to 13 illustrate option 2 of the retraining procedure considering UE mobility.

Referring to FIG. 9, the SMO sends a monitoring request for self-optimization SON function performance (e.g., average CQI, RLF rate, etc.) based on the O1 interface to the E2 nodes.

Thereafter, the following loop is performed while the KPI of a particular self-optimization SON function is low: The E2 node(s) respond to the monitoring request. The SMO retrieves data and sends the data to the Non-RT RIC.

The SMO requests that the E2 nodes collect data about the UE for the self-optimization SON function based on the O1 interface (e.g., UE GPS data). The E2 nodes respond to the data collection request, from the SMO, related to the UE for the self-optimization SON functions based on the O1 interface and transmit UE GPS data, etc. The SMO requests that the Non-RT RIC retrieve the data.

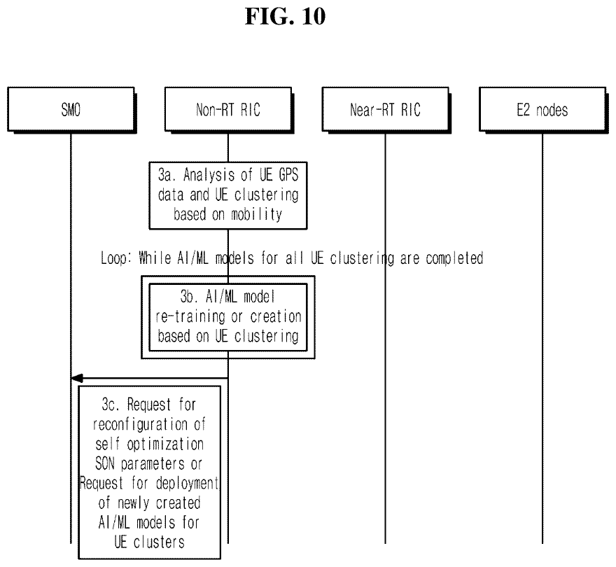

Referring to FIG. 10, the Non-RT RIC performs analysis of UE GPS data and UE clustering based on mobility. Until the AI/ML models for all UE clustering are completed, retraining or creation of AI/ML models based on UE clustering is performed. The Non-RT RIC sends, to the SMO, a request for reconfiguration of the self-optimization SON parameters or a request for deployment of newly created AI/ML models for UE clustering.

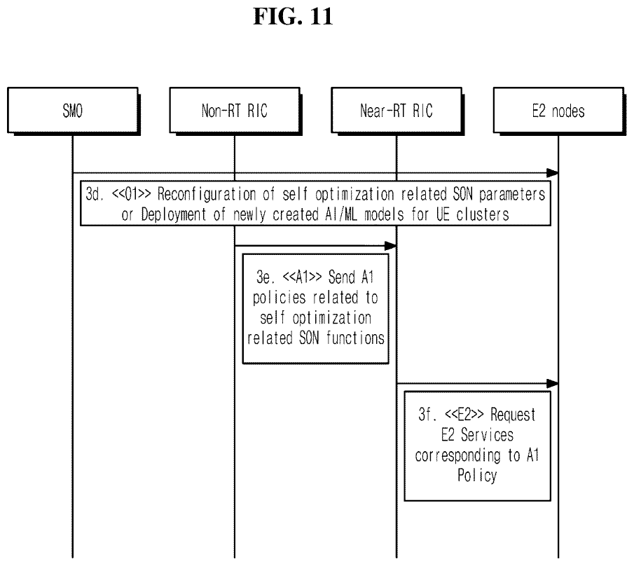

Referring to FIG. 11, the SMO may request, from the E2 nodes, reconfiguration of self-optimization-related SON parameters or deployment of newly created AI/ML models for UE clusters based on the O1 interface. The Non-RT RIC transmits AI policies related to self-optimization related SON functions to the Near-RT RIC based on the A1 interface. The Near-RT RIC may request, from the E2 nodes, E2 services corresponding to the AI policies based on the E2 interface.

FIGS. 12 and 13 illustrate retraining procedures according to embodiments.

Referring to FIG. 12, the Near-RT RIC requests, from the E2 nodes, monitoring for the performance of the self-optimization SON functions (e.g., average CQI, RLF rate, etc.) based on the E2 interface. While the KPIs of certain self-optimization SON functions are low, the following loop is performed: The E2 nodes respond to the Near-RT RIC to monitor the KPIs of self-optimization SON functions (e.g., CQI, RLF rate, etc.) based on the E2 interface.

The Near-RT RIC requests data collection related to the UE for the self-optimization SON functions (e.g., UE GPS data, etc.) based on E2 interface. The E2 nodes transmit data (e.g., UE GPS data) to the Near-RT RIC in response to data collection related to the UE for the self-optimization SON functions based on the E2 interface.

Referring to FIG. 13, the Near-RT RIC analyzes UE GPS data and UE clustering based on UE mobility. The following loop is performed until all AI/ML models for UE clustering are completed: Based on UE clustering, AI/ML model retraining or creation is performed.

The Near-RT RIC requests, from the E2 nodes, reconfiguration of self-optimization SON parameters or deployment of newly generated AI/ML models for UE clusters based on the E2 interface. The Near-RT RIC initiates requests for RRM operations such as HO, cell reselection, etc. to the E2 nodes based on the E2 interface.

Referring to FIG. 2, a method of controlling a network based on an O-RAN may include requesting data collection for a distributed SON from an E2 node by an SMO, transmitting, by the E2 node, data in response to the request for data collection for the distributed SON to the SMO, transmitting, by the SMO, the data to a Non-RT RIC, training, by the Non-RT RIC, an AI/ML model and performing inference for the distributed SON of the E2 node, and requesting, by the Non-RT RIC, reconfiguration of a central SON parameter from the SMO.

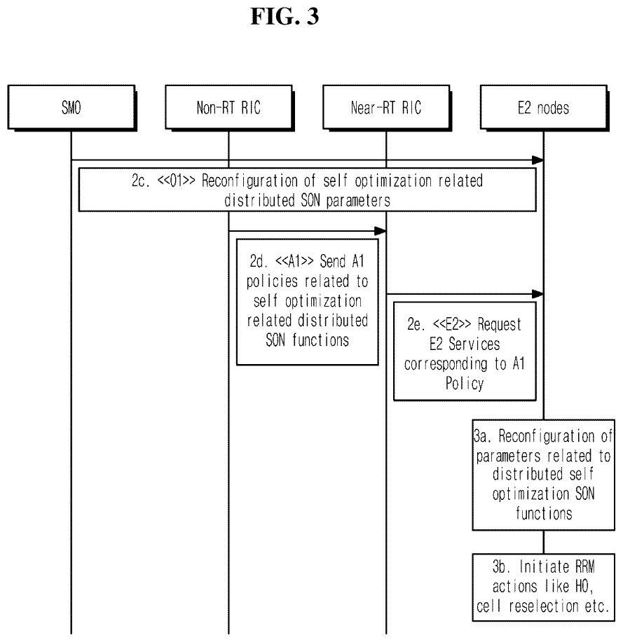

Referring to FIG. 3, the method of controlling the network based on the O-RAN may further include requesting, by the SMO, reconfiguration of a distributed SON parameter from the E2 node, transmitting, by the Non-RT RIC, policy information related to the distributed SON to a Near-RT RIC, requesting, by the Near-RT RIC, a service corresponding to the policy information from the E2 node, reconfiguring, by the E2 node, a parameter related to the distributed SON, and performing RRM by the E2 node.

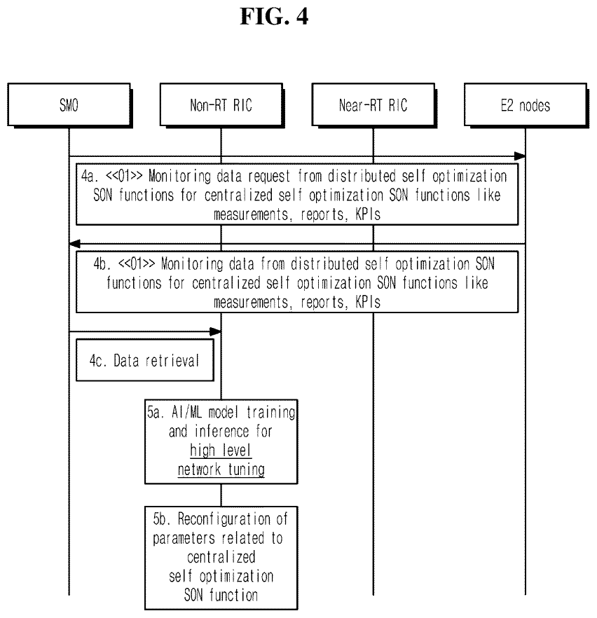

Referring to FIG. 4, the method of controlling the network based on the O-RAN may further include requesting, by the SMO, data monitoring from the distributed SON for the central SON from the E2 node, transmitting, by the E2 node, data in response to the request for data monitoring to the SMO, transmitting, by the SMO, the data to the Non-RT RIC, training, by the Non-RT RIC, the AI/ML model and performing inference for network tuning, and reconfiguring, by the Non-RT RIC, a parameter related to the center SON.

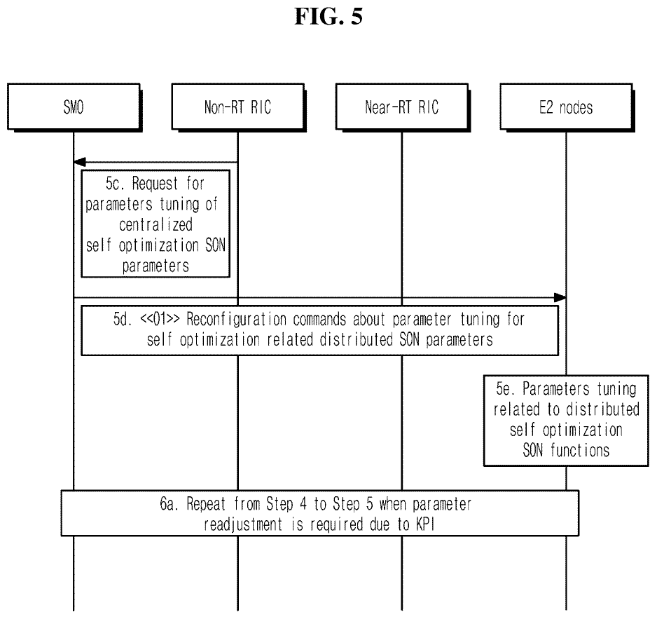

Referring to FIG. 5, the method of controlling the network based on the O-RAN may further include requesting, by the Non-RT RIC, parameter tuning of the center SON from the SMO, requesting, by the SMO, reconfiguration of parameter tuning for a parameter related to the distributed SON from the E2 node, and tuning, by the E2 node, the parameter related to the distributed SON.

Referring to FIG. 6, the method of controlling the network based on the O-RAN may further include requesting, by a Near-RT RIC, data collection for a distributed SON from an E2 node, transmitting, by the E2 node, data in response to the request for data collection from the Near-RT RIC, training, by the Near-RT RIC, an AI/ML model and performing inference for the distributed SON of the E2 node, requesting, by the Near-RT RIC, reconfiguration of a parameter related to the distributed SON from the E2 node, and requesting, by the Near-RT RIC, RRM from the E2 node.

Referring to FIG. 7, the method of controlling the network based on the O-RAN may further include reconfiguring, by the E2 node, the parameter related to the distributed SON, performing the RRM by the E2 node, requesting, by the Near-RT RIC, data monitoring from the distributed SON for a center SON from the E2 node, and transmitting, by the E2 node, data in response to a request for data monitoring from the distributed SON for the center SON to the Near-RT RIC.

Referring to FIG. 8, the method of controlling the network based on the O-RAN may further include training, by the Near-RT RIC, an AI/ML model and performing inference for network tuning, reconfiguring a parameter related to the center SON, and tuning, by the Near-RT RIC, the parameter related to the distributed SON to the E2 node.

Referring to FIG. 9, the method of controlling the network based on the O-RAN may further include requesting, by the SMO, monitoring of performance of the distributed SON from the E2 node, responding, by the E2 node, to the request for the monitoring from the SMO, transmitting, by the SMO, data related to the monitoring to the Non-RT RIC, requesting, by the SMO, data collection related to a UE for the SMO from the E2 node, responding, by the E2 node, to the request for the data collection from the SMO, and transmitting, by the SMO, data related to the collection to the Non-RT RIC.

Referring to FIG. 10, the method of controlling the network based on the O-RAN may further include analyzing, by the Non-RT RIC, UE location data and UE clustering based on mobility, retraining or creating, by the Non-RT RIC, the AI/ML model based on the UE clustering, and requesting, by the Non-RT RIC, reconfiguration of a SON parameter or deployment of the AI/ML model from the SMO.

Referring to FIG. 11, the method of controlling the network based on the O-RAN may further include requesting, by the SMO, reconfiguration of the SON parameter or deployment of the AI/ML model from the E2 node, transmitting, by the Non-RT RIC, policy information related to a SON from a Near-RT RIC, and requesting, by the Near-RT RIC, a service corresponding to the policy information from the E2 node.

Referring to FIG. 12, the method of controlling the network based on the O-RAN may further include requesting, by the Near-RT RIC, monitoring of SON performance from the E2 node, responding, by the E2 node, to the request for the monitoring from the Near-RT RIC, requesting, by the Near-RT RIC, data collection related to a UE for a SON from the E2 node, and responding, by the E2 node, to the request for the data collection from the Near-RT RIC.

Referring to FIG. 13, the method of controlling the network based on the O-RAN may further include analyzing, by the Near-RT RIC, UE location information and UE clustering based on mobility, retraining or creating, by the Near-RT RIC, the AI/ML model based on the UE clustering, requesting, by the Near-RT RIC, reconfiguration of a SON parameter or deployment of the AI/ML model from the E2 node, and requesting, by the Near-RT RIC, RRM from the E2 node.

The embodiments enable efficient network management and optimization. It is possible to improve O-RAN flexibility and real-time network processing capability. The central SON, which analyzes the overall data of the network and creates optimization policies, and the distributed SON, which performs network-level optimization, may be combined to optimize the O-RAN network as a whole. In addition, by retraining the AI/ML model based on handover, cell reselection, network performance, and UE mobility, network optimization policies may be established and high-quality network services may be provided.

The embodiments have been described in terms of a method and/or a device, and the descriptions of the method and the device may be applied complementarily.

For convenience of description, each drawing is described separately, but it is also possible to design a new embodiment to implement the embodiment by combining the embodiments described in each drawing. In addition, designing a computer-readable recording medium in which a program for executing the previously described embodiments is recorded according to the needs of a person skilled in the art is within the scope of the rights of the embodiments. The device and method according to the embodiments are not limited to the configurations and methods of the embodiments described above, but the embodiments may be configured by selectively combining all or part of the embodiments so that various modifications may be made. Even though preferred embodiments of the embodiments have been illustrated and described, the embodiments are not limited to the specific embodiments described above, various modifications may be made by a person having ordinary skill in the art to which the present invention pertains without departing from the gist of the embodiments claimed in the claims, and such modifications should not be individually understood from the technical idea or prospect of the embodiments.

Various components of the device of the embodiments may be implemented by hardware, software, firmware, or a combination thereof. The various components of the embodiments may be implemented by one chip, for example, one hardware circuit. According to embodiments, the components according to the embodiments may be implemented by separate chips. According to embodiments, at least one of the components of the device of the embodiments may be configured as one or more processors capable of executing one or more programs, and the one or more programs may perform one or more of the operations/methods according to the embodiments or include instructions for performing the operations/methods. Executable instructions for performing the methods/operations of the device according to the embodiments may be stored in non-transitory CRMs or other computer program products configured to be executed by one or more processors, or may be stored in temporary CRMs or other computer program products configured to be executed by one or more processors. In addition, the memory according to the embodiments may be used as a concept including not only a volatile memory (e.g., a RAM, etc.) but also a non-volatile memory, a flash memory, a PROM, etc. In addition, it is possible to adopt implementation in the form of a carrier wave, such as transmission via the Internet. In addition, a processor-readable recording medium may be distributed over a network-connected computer system, so that processor-readable code may be stored and executed in a distributed manner.

In this document, “/” and “,” are interpreted as “and/or”. For example, “A/B” is interpreted as “A and/or B”, and “A, B” is interpreted as “A and/or B”. Additionally, “A/B/C” means “at least one of A, B, and/or C”. In addition, “A, B, C” means “at least one of A, B, and/or C”. Additionally, “or” in this document is interpreted as “and/or”. For example, “A or B” may mean 1) “A” only, 2) “B” only, or 3) “A and B”. In other words, “or” in this document may mean “additionally or alternatively”.

Terms such as “first”, “second”, etc. may be used to describe various components of the embodiments. However, the various components according to the embodiments should not be limited in interpretation by the terms. These terms are merely used to distinguish one component from another. For example, a first user input signal may be referred to as a second user input signal. Similarly, the second user input signal may be referred to as the first user input signal. The use of these terms should be interpreted as not departing from the scope of the various embodiments. Even though the first user input signal and the second user input signal are both user input signals, the user input signals do not mean the same user input signals unless the context clearly indicates otherwise.

The terms used to describe the embodiments are used for the purpose of describing particular embodiments and are not intended to limit the embodiments. As used in the description of the embodiments and in the claims, the singular is intended to include the plural unless the context clearly dictates otherwise. The expression “and/or” is used as a meaning including all possible combinations of terms. The expression “include” describes the presence of features, numbers, steps, elements, and/or components, and does not mean that additional features, numbers, steps, elements, and/or components are not included. Conditional expressions such as “in the case,” “when,” etc., used to describe the embodiments are not intended to be limited to only optional cases. It is intended that, when a particular condition is satisfied, a related action is performed in response to the particular condition, or a related definition is interpreted.

In addition, an operation according to the embodiments described in this document may be performed by a transceiver device including a memory and/or a processor according to the embodiments. The memory may store programs for processing/controlling the operation according to the embodiments, and the processor may control various operations described in this document. The processor may be referred to as a controller, etc. The operations according to the embodiments may be performed by firmware, software, and/or a combination thereof, and the firmware, software, and/or a combination thereof may be stored in the processor or in the memory.

Meanwhile, the operation according to the embodiments described above may be performed by a transmitting device and/or a receiving device according to the embodiments. The transmitting/receiving device may include a transmitting/receiving unit for transmitting and receiving media data, a memory for storing instructions (program code, algorithms, flowcharts, and/or data) for a process according to the embodiments, and a processor for controlling operations of the transmitting/receiving device.

The processor may be referred to as a controller, etc., and may correspond to, for example, hardware, software, and/or a combination thereof. The operation according to the embodiments described above may be performed by the processor.

The embodiments provide an efficient O-RAN framework.

The embodiments provide an efficient SON function in an O-RAN architecture framework.

The embodiments may address issues found in vendor-specific SON implementation.

What is claimed is:

1. A method of controlling a network based on an open radio access network (O-RAN), the method comprising:
requesting data collection for a distributed SON (Self-Organizing Network) from an E2 node by an SMO (Service Management and Orchestration);
transmitting, by the E2 node, data in response to the request for data collection for the distributed SON to the SMO;
transmitting, by the SMO, the data to a Non-RT RIC (Non-real time RAN Intelligent Controller);
training, by the Non-RT RIC, an AI/ML (Artificial Intelligence/Machine Learning) model and performing inference for the distributed SON of the E2 node; and
requesting, by the Non-RT RIC, reconfiguration of a central SON parameter from the SMO.

2. The method according to claim 1, further comprising:
requesting, by the SMO, reconfiguration of a distributed SON parameter from the E2 node;
transmitting, by the Non-RT RIC, policy information related to the distributed SON to a Near-RT RIC (Near-real time RAN Intelligent Controller);
requesting, by the Near-RT RIC, a service corresponding to the policy information from the E2 node;
reconfiguring, by the E2 node, a parameter related to the distributed SON; and
performing RRM (Radio Resource Management) by the E2 node.

3. The method according to claim 2, further comprising:
requesting, by the SMO, data monitoring from the distributed SON for the central SON from the E2 node;
transmitting, by the E2 node, data in response to the request for data monitoring to the SMO;
transmitting, by the SMO, the data to the Non-RT RIC;
training, by the Non-RT RIC, the AI/ML model and performing inference for network tuning; and
reconfiguring, by the Non-RT RIC, a parameter related to the center SON.

4. The method according to claim 3, further comprising:
requesting, by the Non-RT RIC, parameter tuning of the center SON from the SMO;
requesting, by the SMO, reconfiguration of parameter tuning for a parameter related to the distributed SON from the E2 node; and
tuning, by the E2 node, the parameter related to the distributed SON.

5. A method of controlling a network based on an O-RAN, the method comprising:
requesting, by a Near-RT RIC, data collection for a distributed SON from an E2 node;
transmitting, by the E2 node, data in response to the request for data collection from the Near-RT RIC;
training, by the Near-RT RIC, an AI/ML model and performing inference for the distributed SON of the E2 node;
requesting, by the Near-RT RIC, reconfiguration of a parameter related to the distributed SON from the E2 node; and
requesting, by the Near-RT RIC, RRM from the E2 node.

6. The method according to claim 5, further comprising:
reconfiguring, by the E2 node, the parameter related to the distributed SON;
performing the RRM by the E2 node;
requesting, by the Near-RT RIC, data monitoring from the distributed SON for a center SON from the E2 node; and
transmitting, by the E2 node, data in response to a request for data monitoring from the distributed SON for the center SON to the Near-RT RIC.

7. The method according to claim 6, further comprising:
training, by the Near-RT RIC, an AI/ML model and performing inference for network tuning;
reconfiguring a parameter related to the center SON; and
tuning, by the Near-RT RIC, the parameter related to the distributed SON to the E2 node.

8. The method according to claim 1, further comprising:
requesting, by the SMO, monitoring of performance of the distributed SON from the E2 node;
responding, by the E2 node, to the request for the monitoring from the SMO;
transmitting, by the SMO, data related to the monitoring to the Non-RT RIC;
requesting, by the SMO, data collection related to a UE for the SMO from the E2 node;
responding, by the E2 node, to the request for the data collection from the SMO; and
transmitting, by the SMO, data related to the collection to the Non-RT RIC.

9. The method according to claim 8, further comprising:
analyzing, by the Non-RT RIC, UE location data and UE clustering based on mobility;
retraining or creating, by the Non-RT RIC, the AI/ML model based on the UE clustering; and
requesting, by the Non-RT RIC, reconfiguration of a SON parameter or deployment of the AI/ML model from the SMO.

10. The method according to claim 9, further comprising:
requesting, by the SMO, reconfiguration of the SON parameter or deployment of the AI/ML model from the E2 node;
transmitting, by the Non-RT RIC, policy information related to a SON from a Near-RT RIC; and
requesting, by the Near-RT RIC, a service corresponding to the policy information from the E2 node.

11. The method according to claim 5, further comprising:
requesting, by the Near-RT RIC, monitoring of SON performance from the E2 node;
responding, by the E2 node, to the request for the monitoring from the Near-RT RIC;
requesting, by the Near-RT RIC, data collection related to a UE for a SON from the E2 node; and
responding, by the E2 node, to the request for the data collection from the Near-RT RIC.

12. The method according to claim 11, further comprising:
analyzing, by the Near-RT RIC, UE location information and UE clustering based on mobility;
retraining or creating, by the Near-RT RIC, the AI/ML model based on the UE clustering;
requesting, by the Near-RT RIC, reconfiguration of a SON parameter or deployment of the AI/ML model from the E2 node; and
requesting, by the Near-RT RIC, RRM from the E2 node.
